(19) United States
(12) Patent Application Publication
(10) Pub. No.: US 2025/0153468 A1
(43) Pub. Date: May 15, 2025

(54) Polymeric Structures for Packagings

(71) Applicants: Stefano Mancinelli, Terni (IT); ESSE C.I. –SOCIETA’ COSTRUZIONI INDUSTRIALI- S.R.L., Narni (TR) (IT); GARGOYLE 1904 DI RICCARDO BALLONI S.A.S., Massa (MS) (IT)

(72) Inventors: Stefano Mancinelli, Terni (IT); Riccardo Balloni, Vedano Al Lambro (IT)

(21) Appl. No.: 18/837,790

(22) PCT Filed: Feb. 9, 2023
(86) PCT No.: PCT/IB2023/051181

§ 371 Date: Aug. 12, 2024

(30) Foreign Application Priority Data
Feb. 14, 2022 (IT) 102022000002636

(51) Int. Cl. B32B 27/08; B29C 48/08; B29C 48/21; B29C 71/02; B29K 23/00; B29L 31/00; B32B 27/16; B32B 27/30; B32B 27/32

(52) U.S. Cl. CPC B32B 27/08; B29C 48/08; B29C 48/21; B29C 71/02; B32B 27/16; B32B 27/306; B32B 27/32; B29K 2023/12; B29L 2031/712; B32B 2250/24; B32B 2255/10; B32B 2255/205; B32B 2255/26; B32B 2255/28; B32B 2307/7376; B32B 2439/70

(57) ABSTRACT

Polymeric structure for flexible packagings includes a polymeric base film and at least one first surface layer, which is applied on at least one surface of the base film, wherein at least one surface of the base film or at least one surface of the first surface layer is treated with nitrous flame, NFT, in which hydrogen-containing mixtures are used as fuel gas. The polymeric structure further comprises at least one first coating applied on at least one surface of the at least one first surface layer, without the use of any primer.

### BACKGROUND OF THE DISCLOSURE

### 1. The Field of the Disclosure

The present invention relates to polymeric structures for packagings.

In particular, the present invention relates to nitrous flame treated polymeric structures (Nitrous Flame Treatment-NFT) for use as flexible packagings in the food industry, in particular suitable for primer-free coating, metallization, printing and lamination application.

### 2. The Relevant Technology

As is known, regenerated cellulose films, generally known as “Cellophane”, coated with thermoplastic resins have been widely used in the past to improve their sealability and gas and water vapour barrier properties, especially in the field of the flexible packaging for the food industry. Subsequently, Cellophane was replaced by plastic films in general, and in particular by bi-oriented polypropylene film (BOPP) which represents the best protection for the food product packaging at the lowest possible cost, having better physical/mechanical properties, although less thermal stability and greater sensitivity to temperatures above 120° C., thus being more difficult to heat seal.

The structures used for flexible packagings in the food sector have three main functions:
1) Protection (against water vapour, oxygen, light-when required, flavours and fragrances); for this purpose, bag packages must be hermetically sealed and resealable. To achieve this objective, the substrates are coated and metallized.
2) Distribution: the packaging structures and the films/materials that compose them must be workable by the packaging machines. The first characteristic required of the flexible packaging films is sealability, with an appropriate balance between different properties, such as the heat sealing force, the heat adhesion force, the sealing start temperature and cost-effectiveness. To achieve the sealability properties, the plastic films are coated and coupled with other plastic resins.
3) Presentation: the packaging structures must be printable on their external surfaces.

The structures and the materials for flexible packaging, in addition to the physical, mechanical and workability characteristics listed above, must be economical and as ecological as possible.

The structures currently known and used for packagings require compatibility with different materials and are made by lacquering and coupling processes.

Plastic films, and in particular bi-oriented polypropylene (BOPP), are not usable unless they are previously prepared and treated, by introducing chemical groups and radicals capable of reacting with the materials suitable for the purpose. It is therefore of particular importance, when designing and manufacturing a flexible packaging structure, the adhesion between the layers and its durability over time.

A known method for performing a surface treatment on a polymeric substrate, for example for improving the wettability of the polymeric film and/or modifying its reactivity, is described in document U.S. Pat. No. 5,753,754A. The method comprises a surface treatment with a flame fed by a mixture of fuel and oxidant, a compound containing oxygen or nitrogen or oxygen and nitrogen.

A known polymeric film, in particular a film of bi-oriented polypropylene BOPP, is described in patent application EP2960054A1. At least one free surface of the film is treated with a flow of non-thermal plasma at a pressure greater than atmospheric pressure.

A further example of multilayer film for flexible packagings is described in document EP1820642A1. The multilayer film is constituted in this case by a polypropylene base layer and two coating layers, and a high viscosity silicone polymer used as a lubricating agent is added to at least one of the coatings.

Document US2004/033378A1 discloses a bi-axially oriented multilayer polyolefinic film comprising a main layer and at least one protective coating, containing a copolymer or terpolymer.

Also, U.S. Pat. No. 5,753,754A and US2002/182435A1 describe examples of multilayer film for packaging.

Finally, document US2008/014429A1 refers to a film of biaxially oriented polypropylene BOPP comprising a base layer containing polyolefins and an optional cling layer containing PHAE.

The surfaces of the polyolefinic films, if not treated with manufacturing processes, do not allow optimal adhesion between the layers and the duration of such adhesion over time. The industrial processes currently in use for this purpose are:
a) electric shock treatment (corona treatment);
b) flame treatment with natural gases or mixtures thereof.

However, despite these treatments, the adhesion of the various layers to the polyolefinic film (particularly BOPP) is not always sufficient to ensure a product with optimal characteristics.

To date, to overcome this problem, an adhesion promoter (primer or tie layer) is introduced between the polyolefinic faces and in particular BOPP, suitably treated, and the faces of the components applied to them (mainly lacquers, adhesives, etc.). Only in this way it is currently possible to achieve a consistent and durable adhesion between the various layers and the polyolefinic film.

The primers used are generally two-component, also in the already mixed version. The crosslinking of the primer takes place in the presence of oxygen and at high temperature, in drying ovens that allow crosslinking in industrial times of the order of seconds. The use of the primers is regulated by legislation concerning food contact materials (Framework Regulation 1935/2004; Title 21 Code of Federal Regulations-21 CFR). The rules governing the use of the primers are stringent due to the toxicological risk associated with them.

### SUMMARY OF THE DISCLOSURE

In this patent application by primer it is understood to mean substances capable of promoting adhesion, such as for example: polyurethane primers-DSM NeoRez R-600 and NeoRez R-610, in the case of acrylic lacquers; polyurethane primers-DSM NeoRez R-610—or polyurethane/polyester ones BASF Epotal, for PVDC lacquers; polyethyleneimine (PEI)—BASF Lupasol WF—for PVOH/EVOH lacquers.

Aim of the present invention is to provide polymeric structures for packagings and a technology for preparing polyolefinic surfaces (in particular BOPP), such that the use of primers is not required.

Advantageously, the elimination of the primer allows, in addition to the removal of any toxicological risk related to its use, also an economic saving and an improvement of the ecological impact, since currently the residual material in the coating tanks is not reusable and is discarded as toxic waste.

According to the present invention, polymeric structures are provided for packagings and which are pretreated with nitrous flame treatments (NFT), which do not require any primer to guarantee the adhesion between layers of the structure itself and the adhesion, that is non-delamination, of coatings such as lacquers, aluminium and its AlOₓ oxides, other metals, inks or polymers on their external surfaces.

The use of the primer is in fact superfluous if the polyolefinic surfaces (in particular BOPP) are treated with the Nitrous Flame Treatment (NFT) process. The flame of the Nitrous Flame Treatment (NFT) activates the substrates, while these pass on a flame roller at a controlled temperature. The combustion mixture is formed by air and gas, typically natural gas, methane, propane gas, liquefied propane gas, but other types of fuel are possible, to which a certain volumetric fraction of nitrous oxide, controlled by the use of mass flow metres, is added. The nitrous flame (NFT) contains reactive species, in the gaseous phase, such as O₂, OH, H, NO, NO₂, HNO and N₂O, which, by effect of the high temperatures developed by the flame itself, functionalize the surface of the treated material, introducing on it hydrocyanic and nitrogen-carbon-oxygen-based groups, which are absent in a standard flame-treated (SFT) or corona-treated surface, which have exclusively oxygen-based functionalities.

The nitrous flame treatment (NFT) is produced by a combustion mixture of air, as oxidant, and natural gas or pure methane, pure propane, LPG as fuel component, addition of nitrous oxide, in a molar percentage interval typically (but not exclusively) comprised between 3% and 15%. The use of mixtures of natural gases with hydrogen, up to percentages of the order of 20% and above, allows to maximize the effect of NFT, increasing the flame temperature.

For the sake of the goodness of the production process of the polymeric structures according to the invention, it is in fact essential to tightly control both the amount of energy supplied and its quality (flame temperature and reaction temperature).

According to the present invention a polymeric structure for packagings is realized, as defined in claim 1.

### BRIEF DESCRIPTION OF THE DRAWINGS

For a better understanding of the present invention, a preferred embodiment is now described, by way of non-limiting example only, with reference to the accompanying drawings, in which:

FIG. 1 shows a schematic view of the polymeric structure for packagings according to a first embodiment of the invention;

FIG. 2 shows a schematic view of the polymeric structure for packagings according to a second embodiment of the invention;

FIG. 3 shows a schematic view of the polymeric structure for packagings according to a third embodiment of the invention;

FIG. 4 shows a schematic view of the polymeric structure for packagings according to a fourth embodiment of the invention;

FIG. 5 shows a schematic view of the polymeric structure for packagings according to a fifth embodiment of the invention;

FIG. 6 shows a schematic view of the polymeric structure for packagings according to a sixth embodiment of the invention;

FIG. 7 shows experimental results of tests carried out on polymeric structures for packagings according to the invention, and in particular shows the heat sealing resistance values, as the sealing temperature varies, for a first embodiment of the invention, in which the coatings are of the acrylic type on both faces.

### DETAILED DESCRIPTION OF THE PREFERRED EMBODIMENTS

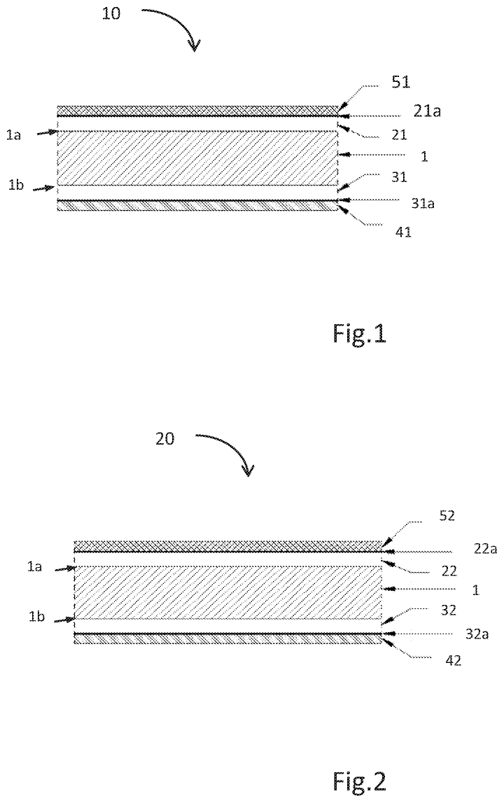

With reference to such figures, and in particular to FIGS. 1-6, a polymeric structure for flexible packagings is shown according to the invention.

In the present invention by bi-oriented polypropylene with high isotactic content, or BOPP, it is meant a bi-oriented polypropylene film with high crystallinity (95%). A polypropylene with these characteristics has, compared to an atactic polypropylene, i.e., amorphous, a higher melting temperature (160° C.-180° C.), higher density and tensile strength, a lower permeability compared to water vapour and to solvents, as well as a higher chemical resistance. For this reason, the bi-oriented polypropylene film used in the polymeric structures for flexible packaging according to the present invention has a dominant isotactic component (typically from 94% to 96%), i.e., it has a high isotactic content, i.e., with only a minority component of the atactic/amorphous type.

In the present invention, by treatment with nitrous flame NFT with hydrogen, at different times it is meant that a first treatment NFT with hydrogen can be applied in the extrusion, during the production of the polyolefinic film (BOPP), while in the subsequent steps of the production process, those of conversion, the film transformer will both coat the surface already treated NFT with hydrogen, and will treat and coat the untreated surface. The treatment at different times is linked to the impossibility of treating both surfaces of the polymeric structure at the same time and in any case before said surface is transformed, coated with another material. This concept, which also applies in the case of standard flame treatments (SFT), is closely linked to the fundamental concept of industrial applicability of the process. In fact, in the event that the two surfaces are treated simultaneously and in any case wound in the form of a reel both treated and not separated by a coating, the problem of the reel sticking occurs, due to the high adhesion between the two treated faces in mutual contact, so that the film, when it is again unwound from the reel, tends to break, making its subsequent use and therefore its industrial use impossible.

The polymeric structure 10, 20, 30, 40, 50, 60 for flexible packagings comprises:
a polymeric base film 1;
at least a first surface layer 21, 22, 23, 24, 25, 26 applied on at least one surface 1a of the base film 1;
wherein at least one surface 1a, 1b of the base film 1, or at least one surface 21a, 22a, 23a, 24a, 25a, 26a of the first surface layer 21, 22, 23, 24, 25, 26, is treated with nitrous flame (NFT), in which use is made, as fuel gas, of mixtures containing hydrogen.

The polymeric structure 10, 20, 30, 40, 50, 60 further comprises at least one first coating 51, 52, 53, 54, 55, 56 applied on at least one surface 21a, 22a, 23a, 24a, 25a, 26a of the at least one first surface layer 21, 22, 23, 24, 25, 26, without the application or the use of any primer.

According to one aspect of the invention, the base film 1 is constituted by a homopolymer in bi-oriented polypropylene with high isotactic content (BOPP).

According to one aspect of the invention, the base film 1 is made of a material selected from the group constituted by: polyolefins, oriented and not, poly (ethylene terephthalate)-PET, bi-oriented poly (ethylene terephthalate)-BOPET, bi-oriented polyamide (BOPA), synthetic paper (SYNPA), Fluoropolymers such as polyvinyl fluoride (PVF), polyvinylidene fluoride (PVDF), polytetrafluoroethylene (PTFE), polyvinyl chloride (PVC), Cast PP (Polypropylene), Nylon, PE (polyethylene), PA (Polyamide), Cellophane, PLA (polylactate), PHA (polyhydroxyalkanoates), PHB (poly-β-hydroxybutyrate), PS (polystyrene), Bioplastic films (based on maize, wheat starch, tapioca, potato starch).

According to one aspect of the invention, the base film 1 is a film in bi-oriented polypropylene (C3) with high isotactic content (BOPP), having a thickness comprised between 6 μm and 100 μm, homopolymer or, according to some preferred embodiments of the polymeric structure 10, 20, 30, 40, 50, 60, coextruded with at least a first surface layer 21, 22, 23, 24, 25, 26 and a second surface layer 31, 32, 33, 34, 35, 36 each constituted by a homopolymer or copolymer or terpolymer layer, and having a thickness comprised between 1 μm and 4 μm, treated on an external surface thereof with a nitrous flame (NFT).

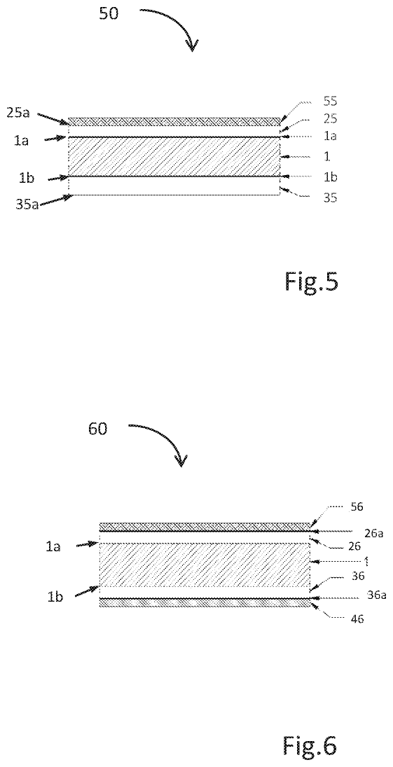

The base film 1 of BOPP, in the fifth embodiment (FIG. 5), is lacquered on its external surfaces 1a and 1b in case it is of the homopolymer type in polypropylene (C3). In other words, in the fifth embodiment, the first surface layer 25 is a lacquer applied on the first surface 1a. In the event base film 1 is a homopolymer, the second surface layer 35 is a lacquer. Otherwise, the second surface layer 35 is a terpolymer skin C2-C3-C4.

In the sixth embodiment (FIG. 6), the base film 1 of BOPP, the external surfaces (26a, 36a) respectively of the first surface layer (26) and of the second surface layer (36) are treated with nitrous flame (NFT), the first coating (56) being in mono-solvent nitrocellulose in ethyl acetate, and the external surface of the second surface layer (36) being coated with a second coating (46) in acrylic or low-sealing lacquer (LTS), without the use of any primer.

The first surface layer 21, 22, 23, 24, 25, 26 and the second surface layer 31, 32, 33, 34, 35, 36 may be of the copolymer type C2-C3 (ethylene-propylene) or C3-C4 (propylene-butylene), or of the terpolymer type C2-C3-C4 (ethylene-propylene-butylene). Then the coating constituted by the lacquer is applied either on a surface in C3 (homopolymer case) or on a surface in C2-C3 and C3-C4 (in the case of copolymer surface film) or on a surface in C2-C3-C4 (in the case of terpolymer surface film).

According to a first embodiment, shown in FIG. 1, the polymeric structure 10 consists of a base film 1, constituted by a homopolymer in bi-oriented polypropylene (C3) with high isotactic content (BOPP), coextruded with a first surface layer 21 and a second surface layer 31 which are applied respectively to its first and to a second surface 1a, 1b, opposite to each other.

Wherein: the first surface layer 21 and the second surface layer 31 are each constituted by a copolymer (ethylene-propylene) or C3-C4 (propylene-butylene), or are of the terpolymer type C2-C3-C4 (ethylene-propylene-butylene). The first surface layer 21 and the second surface layer 31 may be constituted by the same copolymer or terpolymer or by different copolymers/terpolymers. In the first embodiment of the polymeric structure 10, both external surfaces 21a and 31a, i.e., not facing the base film 1, respectively of the first surface layer 21 and of the second surface layer 31, are treated with nitrous flame (NFT), at different times, and respectively a first acrylic coating 51 and a second acrylic coating 41 are applied to said treated external surfaces 21a, 31a.

The surfaces treated with NFT, and in particular the surface 21a of the first surface layer 21 and the surface 31a of the second surface layer 31 are highlighted in FIG. 1, in section.

According to one aspect of the invention, the polymeric structure 10 has a thickness comprised between 6 μm and 100 μm, and preferably equal to 28 microns.

According to one aspect of the invention, the first and the second acrylic coating 51, 41 have a grammage comprised between 0.04 and 5.0 g/m² and do not require any use of primers.

Advantageously, the polymeric structure 10 according to the first embodiment allows to obtain a bi-sealing lacquered film having the following technical specifications:

$$Transparency / Haze ( non - metallized structure ) = good ( HAZE = 5.3 \pm 0.01 \% )$$

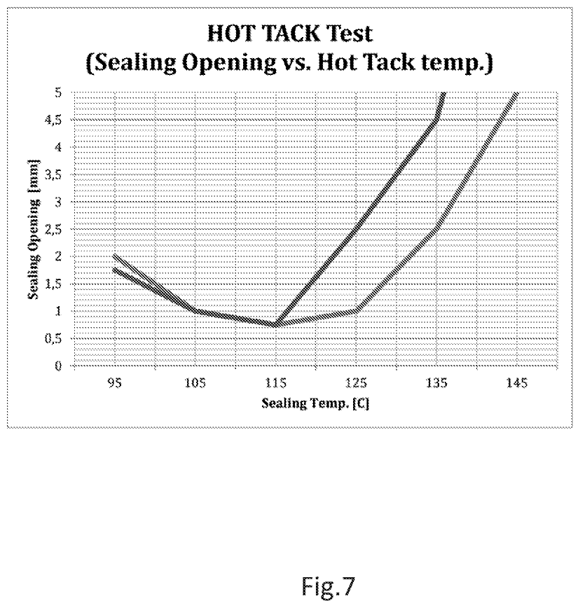

Gloss 132±6 at 60° C.
Sealing resistance>300 g/cm
Hot Tack (Acrylic/Acrylic) good (see FIG. 7)
(<2 mm sealing opening in sealing temperature range 95° C.÷132° C.)

$$WVTR = 4.2 g / ( {m}^{2} d ) \\ OTR = 1550 cc / ( {m}^{2} d ) cc / ( {m}^{2} d ) CSI$$

Flowing quality=static COF 0.57±0.03; dynamic COF 0.52±0.01 on lacquered/lacquered, wherein the above values have been determined as follows:
COF measured according to ASTM standard D1894-2014;
Transparency/Haze measured according to ASTM standard D1003-13;
Gloss measured according to ASTM standard D523-14;
Water vapour transmission (WVTR) measured according to ASTM standard F 1249-20;
Oxygen transmission (OTR) measured according to ASTM standard D 3985-17;

Sealing resistance measured by testing the side coated with the coextruded side of the structure, sealed together at 120° C., with a pressure of the sealing jaws comprised between 1.5 and 3 kg/cm² and a pressure application time of 1 second.

According to a second embodiment of the invention, shown in FIG. 2, the polymeric structure 20 consists of a base film 1 coextruded with a first surface film 22 and a second surface film 32 which are applied respectively to its first and its second surface 1a, 1b. The first and the second surface layer 22, 32 are each constituted by a copolymer (C2-C3 or C3-C4) or a terpolymer (C2-C3-C4), and both the external surfaces 22a and 32a, respectively of the first surface layer 22 and of the second surface layer 32, are treated with nitrous flame, at different times. To each of said treated external surfaces 22a, 32a it is applied respectively a first coating 52 and a second coating 42, without the use of primers. The first coating 52, in the second embodiment, consists of a PVDC lacquer on at least one external surface 22a, 32a respectively of the first or second surface layer 22, 32. In the case where the PVDC lacquer is applied to only one external surface 22a or 32a, the second external surface, 32a or 22a, respectively, has a coating constituted by an acrylic lacquer.

Advantageously, according to the second embodiment, a lacquered film having the following characteristics is obtained:

$$PVDC grammage = 2.5 \div 3. g / {m}^{2} ( for WVTR and OTR barrier increase ) \\ Transparency / Haze ( non - metallized structure ) = good ( HAZE < 3 \% )$$

Gloss≥85%

$$WVTR = 4. \div 6. g / ( m 2 d ) \\ OTR = 20 \div 40 cc / ( m 2 d )$$

Acrylic (Sealing resistance)=like EXAMPLE 1
Flowing quality=static COF 0.57±0.03; dynamic COF 0.52±0.01 on lacquered/lacquered.

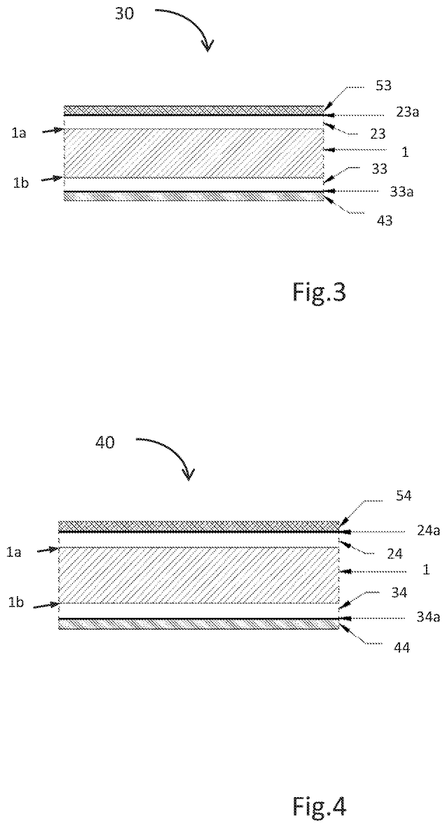

According to a third embodiment of the invention, shown in FIG. 3, the polymeric structure 30 consists of a base film 1 coextruded with a first surface layer 23 and a second surface layer 33 which are applied respectively to its first and its second surface 1a, 1b. The first and the second surface layer 23, 33 are each constituted by a copolymer (C2-C3 or C3-C4) or a terpolymer (C2-C3-C4), and both the external surfaces 23a, 33a of the first surface layer 23 and of the second surface layer 33 are treated with nitrous flame, at different times. To each of said treated external surfaces 23a, 33a it is applied respectively a first coating 53 and a second coating 43, without the use of primers. The first coating 53, in the third embodiment, consists of an acrylic lacquer and the second coating 43 consists of a low-sealing lacquer (LTS).

Advantageously, the third embodiment of the polymeric structure allows to obtain a bi-sealing lacquered film, having the following characteristics:

$$Grammage = 2.5 \div 3. g / m 2 ( for WVTR and OTR barrier increase ) \\ Transparency / Haze ( non - metallized structure ) = good ( HAZE = 5.3 \pm 0.01 \% )$$

Gloss=132±6 at 60° C.

$$WVTR = 4.2 g / ( m 2 d ) \\ OTR = 1550 cc / ( m 2 d ) cc / ( m 2 d ) CSI \\ LTS ( Sealing resistance ) = 300 g / cm at 85 ° C .$$

Flowing quality=static COF 0.57±0.03; dynamic COF 0.52±0.01 on lacquered/lacquered.

According to a fourth embodiment of the invention, the polymeric structure 40 consists of a base film 1 coextruded with a first surface layer 24 and a second surface layer 34 which are applied respectively to its first and its second surface 1a, 1b. The first and the second surface layer 24, 34 are each constituted by a copolymer (C2-C3 or C3-C4) or a terpolymer (C2-C3-C4), and both the external surfaces 24a, 34a of the first surface layer 24 and of the second surface layer 34 are treated with nitrous flame, at different times. To each of said treated external surfaces it is applied respectively a first coating 54 and a second coating 44, without the use of any primer. The first coating 54, in the fourth embodiment, consists of a low-sealing lacquer (LTS) and the second coating 44 consists of a PVDC lacquer. Advantageously, the polymeric structure according to the fourth embodiment allows to obtain a lacquered film having the following characteristics:

$$Transparency / Haze ( non - metallized structure ) = good ( HAZE < 3 \% )$$

Gloss≥85%

$$WVTR = 4. \div 6. g / ( m 2 d ) \\ OTR = 20 \div 40 cc / ( m 2 d )$$

Sealing force: 300 g/cm at 85° C.

According to a fifth embodiment of the invention, the polymeric structure 50, shown in FIG. 5, consists of:
a base film 1 constituted by a homopolymer having both external surfaces 1a, 1b treated with nitrous flame, at different times;
a first surface layer 25 constituted by a coating made of PVOH and/or EVOH lacquer, preferably with grammage comprised in the interval 0.75÷1.0 g/m²;
a second surface layer 35 constituted by a terpolymer skin C2-C3-C4, or a coating in low-sealing lacquer LTS, or acrylic lacquer;
a first coating 55, applied to the first surface layer 25, constituted by an acrylic lacquer, having preferably grammage comprised between 0.6÷1.0 g/m²; both surfaces 1a, 1b of the base film 1, that is of the homopolymer, or both the surface 1a of the base film 1 and the surface 35a of the second surface layer 35, in the case where the second surface layer 35 is a terpolymer, are treated with the nitrous flame NFT, at different times, before lacquering. No primer is used during lacquering.

The surfaces treated with nitrous flame in the fifth embodiment and in particular the surfaces 1a, 1b of the base film 1 are highlighted in FIG. 5.

The properties of the lacquered product obtained according to the fifth embodiment are as follows:

$$Transparency / Haze ( non - metallized structure ) = good ( HAZE < 3 \% )$$

Gloss≥85%

$$WVTR = 2.7 \div 3.2 g / ( m 2 d ) \\ OTR = 10 \div 25 cc / ( m 2 d )$$

Sealing force: >300 g/cm.

The polymeric structures 10, 20, 30, 40, 50 according to all the above embodiments are obtained from polymers in aqueous emulsion or in solvent solution (M.E.K., Ethyl Acetate, Isopropyl Alcohol).

According to another aspect of the invention, the process for producing the polymeric structures for packagings envisages using lacquers in solution.

According to a sixth embodiment, shown in FIG. 6, the polyolefinic polymeric structure 60 consists of a base film 1 constituted by a homopolymer, a first surface layer 26 and a second surface layer 36 in a terpolymer (C2-C3-C4);
wherein both the external surfaces, i.e., not directed towards the base film 1, respectively of the first surface layer 26 and of the second surface layer 36, i.e., 26a and 36a, are treated with nitrous flame NFT, at different times.

The two external surfaces are coated with a coating, and in particular the external surface 26a of the first surface layer 26 is coated with a first coating 56 of mono-solvent nitrocellulose in ethyl acetate, and the external surface 36a of the second surface layer 36 is coated with a second coating 46 of acrylic or low-sealing lacquer LTS, both without the use of any primer.

Nitrocellulose replaces the lacquers based on PVDC, PVOH and EVOH. The polymeric structure 60 according to the sixth embodiment has the following properties: Transparency/Haze (non-metallized structure)=good (HAZE<5.3±0.01%)
Gloss≥128 at 60° C.

$$WVTR = 3.9 \div 4.3 g / ( m 2 d ) \\ OTR = 1600 cc / ( m 2 d )$$

Sealing force: >300 g/cm.

In all the embodiments described above, the first surface coating 51, 52, 53, 54, 55, 56 and the second surface coating 41, 42, 43, 44, 45, 46 have a grammage comprised between 0.40 g/m² and 3.00 g/m².

According to one aspect of the invention, said first surface layer 21, 22, 23, 24, 25, 26 and said second surface layer 31, 32, 33, 34, 35, 36 are constituted by mixtures of a copolymer (C2-C3 or C3-C4) or of a terpolymer (C2-C3-C4), and copolymers coming from aliphatic and cycloaliphatic hydrocarbons or by copolymers coming from aromatic hydrocarbons or from terpene resins.

According to the invention, the nitrous flame treatment of the polymeric structures 10, 20, 30, 40, 50, 60 takes place using, as fuel gas, also mixtures containing hydrogen. Advantageously, the use of hydrogen allows a thermal jump to the nitrous flame and promotes the presence of CN groups on the surface. The use of hydrogen-containing fuel in the nitrous flame is innovative compared to the state of the art.

According to the invention, the first surface layer 21, 22, 23, 24, 25, 26 and the second surface layer 31, 32, 33, 34, 35, 36 are applied to the base film 1 by means of application techniques comprised in the group constituted by: (direct and reverse) rotogravure, offset, rod coating, kiss coating and flexographic printing.

According to one aspect of the invention, the polymeric structures 10, 20, 30, 40, 50, 60 for flexible packagings can be used for the application of self-adhesive labels, or pressure sensitive labels, based on polyolefin to be applied on transparent polyolefin packages.

The labels are used for the identification of the packaged pack and for the description of its content. The advantage of using these labels is that at the end of the use of the packaging such labels can be detached and separated from the packaging itself, making it recyclable. The self-adhesive labels are currently printed with UV inks. The materials used in the production of self-adhesive labels are of various type: paper, plastic films, mainly polyesters and P.V.C. Bi-oriented polypropylene (BOPP) is the most suitable material to be used for printing self-adhesive labels, to be applied on packages intended for food packaging.

Currently for the production of self-adhesive labels in BOPP, printing with UV inks requires applying a lacquer on the face pre-treated with standard flame treatment (SFT) or corona treatment, as the latter alone are not enough to guarantee the adhesion of the inks.

The use of the polymeric structures 10, 20, 30, 40, 50, 60 according to the invention, in which a surface 1a, 1b of the base film 1 in BOPP is treated with flame treatment NFT, advantageously allows the use of UV inks directly, without a pre-lacquering thereof.

According to one aspect of the invention, the lacquered polyolefin structures 10, 20, 30, 40, 50, 60 comprise a coating constituted by an aluminium layer (metallization process), deposited on the base film 1 constituted by a film of bi-oriented polypropylene with high isotactic content (BOPP), with thickness comprised between 6 μm÷100 μm, possibly coextruded (bi- or mono-coextruded), according to structures analogous to those of the examples described above. The aluminium layers have an optical density in the interval 0.5÷5.

Polymeric structures are currently known in which the metallizable face is generally treated with standard flame treatment (SFT) technology. The evaluation of the adhesion of the aluminium layer deposited on the mentioned polyolefin structure is carried out by means of adhesive tape applied immediately on the metallized face and then it is visually estimated how much aluminium is transferred from the metallized face to the applied tape (ISO 2409 standard). A quantitative method for evaluating the validity of the adhesion of aluminium on the metallized face is constituted by “Rexam”, which consists in applying an adhesiveised polyester film or EAA (ethylene acrylic acid) on the metallized face. The sample thus treated is placed, by means of a sealing machine, in contact with two jaws, one of which is heated to 110° C., for one second. A 1 cm wide strip is obtained from the sample. The evaluation of the adhesion of the metal on the sample thus obtained is assessed with the aid of a dynamometer.

The values obtained in the case of using Standard Flame Treatment (SFT) and Nitrous Flame Treatment (NFT) are shown hereinbelow:
1) Adhesion Al metallized structure on film treated with standard flame SFT exiting the metallizer:
   a) Al on homopolymer=300 g/cm÷400 g/cm;
   b) Al on terpolymer=800 g/cm÷1000 g/cm.
2) Adhesion Al metallized structure on SFT-treated film after 4-week curing:
   a) Al on homopolymer=100 g/cm÷250 g/cm;
   b) Al on terpolymer=200 g/cm÷300 g/cm.
3) Adhesion Al metallized structure on NFT-treated film exiting the metallizer:
   a) Al on homopolymer=800 g/cm÷1000 g/cm;
   b) Al on terpolymer=1000 g/cm÷1200 g/cm.
4) Adhesion Al metallized structure on NFT-treated film after 4-week curing:
   a) Al on homopolymer=400 g/cm÷500 g/cm;
   b) Al on terpolymer=600 g/cm÷1000 g/cm.

FIG. 7 shows the heat sealing resistance values, as the sealing temperature varies, for the first embodiment of the invention, wherein the first and the second coating are of the acrylic type. This heat sealing resistance, called Hot Tack, is measured immediately after the sealing has been produced and before it is cooled to room temperature. This is a very important property, because it reproduces what occurs in very common vertical packaging machines, such as VFFS (Vertical Form-Fill-Seal).

The polymeric structures 10, 20, 30, 40, 50, 60 for previously described and claimed packagings, in case they envisage the use of lacquers, have a preferred lacquering interval (both water and solvent based) comprised between 0.04 g/m² and 5 g/m². The lacquers used are preferably of the Acrylic, LTS, PVDC, PVA, PVOH, EVOH type, lacquers deriving from amino acids.

Preferably, said first coating 51, 52, 53, 54, 55, 56 is constituted by a lacquer, applied without the use of primers, comprised in the group constituted by: acrylic lacquer, PVDC lacquer, or a low-sealing lacquer. Preferably, the second coating 41, 42, 43, 44, 45, 46 is constituted by a lacquer, applied without the use of primers, comprised in the group constituted by: acrylic lacquer, PVDC lacquer, nitrocellulosic lacquer and polyester.

In the polymeric structures according to the present invention, it is possible, given the consistent and lasting adhesion between the various layers of the polyolefinic film even in the absence of use of primers, to recognize that the nitrous flame process has been applied, either simple or enriched with hydrogen, and to distinguish this case from that of polymeric films to which a corona or nitrous plasma treatment has been applied. In the latter case, in fact, it is not possible to eliminate the use of the primer, under penalty of delamination of the layers, and the loss of the sealing properties of the lacquered surface.

The distinction between a polymeric structure treated with simple NFT or NFT with hydrogen is more difficult to carry out and quantify; it requires a quantification on a statistical basis; both processes (simple NFT and NFT+H₂) allow in fact the elimination of the primer from the polymeric structures for flexible packagings described, although in terms of adhesion force and sealing force the results obtained from nitrous flame with hydrogen are higher than those obtained with simple flame NFT.

A standard flame SFT (stoichiometric air/propane combustion mixture) develops temperatures of the order of about 1925° C., a simple flame NFT in propane develops, under stoichiometric conditions, theoretical temperatures equal to about 2550° C., while a flame NFT+hydrogen develops, always under stoichiometric conditions, a theoretical temperature of about 3450° C. This remarkable thermal jump, also visible to the naked eye from the change in colour of the flame, which turns from light blue to white, allows the flame treatment to be more incisive in breaking the carbon-hydrogen bonds present along the macromolecular chain of the polyolefin (for example polypropylene), whose surface is flame-treated.

The functionalization of the surface of the flame-treated material, defined in the literature as Free Radical Degradation, consists in fact of a radical reaction, which begins with the attack of radical species to the tertiary carbon of the polypropylene macromolecule and subsequent breaking of the C—H bond. This first step of the radical reaction is endothermic (the dissociation energy of the C—H bond is 451 KJ/mol), therefore favoured by a higher temperature of the flame and by the consequent increase in heat available in the combustion system, and produces an alkyl radical, i.e., a polymeric radical, obtained from the initial polymer by removing from it the hydrogen atoms linked to the tertiary carbons of the macromolecules.

Advantageously, the higher temperature of the flame NFT+H₂ compared to that of the simple flame NFT results in an increase of hydrogen atoms extracted from the macromolecules and therefore of the free sites, along the macromolecules themselves, in which the reactive species (O₂, OH, H, NO, NO₂, HNO and N₂O) contained in the nitrous flame (NFT) can graft.

The introduction of hydrogen into the NFT and the resulting increase in flame temperature leads to a more extensive functionalization of the treated polymer, not only by effect of the increase in the reactive sites produced along its macromolecules, as described above, but also by effect of the increase in concentration in the combustion system of hydrocyanic and carbon-nitrogen-oxygen-based radicals.

At the higher temperatures produced by the nitrous flame, additivated with hydrogen (real, non-theoretical flame temperatures higher than 2100K), the attack of oxygen radicals to the atmospheric nitrogen results in the formation of NO radicals, while, always thanks to the higher temperature reached by the combustion system, also the nitrogen-containing compounds present in the fuel (like in the case of use of methane/hydrogen mixtures, known as hydromethane), in the form of ammonia, pyridine and, more generally, amines (R—NH2, where R is an organic radical or a hydrogen atom) undergo a thermal decomposition, with formation of low molecular weight radicals containing nitrogen (NH₃, NH₂, NH, HCN, CN), which can then be oxidized by hydroxyl radicals (OH) and with oxygen or molecular nitrogen, present in the combustion environment, to form NO and HNO.

In summary, the introduction of hydrogen into the mixture, with the resulting increase in the nitrous flame temperature (NFT), increases the number of functional groups and, in particular, of those nitrogen-based groups linked, after treatment, to the macromolecules of the polymer.

This results in an increase in the surface energy of the polymer after treatment NFT+hydrogen, compared to the case of treatment with simple nitrous flame (NFT) and consequently an increase in the adhesion and in the consistency of any type of coating on the treated surface.

From an adhesion point of view, it is useful here to underline the decisive role played by nitrogen-based radicals introduced with a simple nitrous flame (NFT) and in higher concentrations with the flame NFT+hydrogen.

In fact, when nitrogen is included in the functional groups, its trivalent state favours the development of cross-linking, that is, a cross-linking that creates a three-dimensional and stable network of molecules on the surface of the treated polymer.

This network of nitrogen-containing molecules produces the following beneficial effects for the purposes of adhesion:
1) avoids the hydrophobic recovery or intermixing with the bulk of the polymer, i.e., avoiding the mixing of the functional groups introduced by the treatment on the surface with the underlying, non-functionalized macromolecules of the polymer;
2) allows a better anchoring of the functional groups introduced to the treated surface of the polymer, even under conditions of high ambient temperatures and humidity (tropical conditions);
3) strengthens the bond of the boundary layer of the polymer (the one that binds to the applied coating) with the bulk of the polymer itself, reducing the possibilities of delamination due to lack of cohesion of this layer with the rest of the material (a phenomenon known as WBL, weak boundary layer). The bond between the boundary layer and the polymer bulk is also reinforced by the elimination of the oligomers present on the film surface, which can produce WBL issues, thanks to the higher flame temperature produced by the flame NFT with hydrogen.

The present invention also concerns a process for producing the polymeric structure 10, 20, 30, 40, 50, 60 for flexible packagings, according to one of the preceding embodiments, comprising the following steps:
a first step of stretching a mono-oriented polypropylene film, i.e., oriented in the machine direction, until a film having a thickness comprised in the interval from 160 μm to 550 μm and a width comprised in the range 1.0 μm-1.2 μm is obtained;
a second step of stretching the polypropylene, in a direction transverse to the first step, up to a film thickness comprised in the interval from 18 μm to 60 μm and a width comprised in the range 6.6 μm-10.4 μm;
flame treatment NFT or NFT with addition of hydrogen on at least one of the faces of the film obtained from the previous steps;
deposition on the face previously treated by NFT or NFT and H₂, by Reverse Gravure and Kiss Coating technique, of a high oxygen barrier lacquer, used with or without addition of primers.

The use of nitrous flame (NFT) and preferably that of hydrogen-enriched flame NFT, by virtue of the more extensive resulting functionalization, especially in nitrogen, of the macromolecules, allows to guarantee the adhesion and the consistency of the various layers of the polyolefinic film (in particular of BOPP), assuring the product optimal characteristics, without the need to introduce an adhesion promoter (primer or tie layer) between the polyolefinic faces and the faces of the components applied to them (mainly lacquers, adhesives, inks, etc.), as instead it has been done since the origins of the lacquered films (early 1960s) and still today by the food and non-food packaging film production industry. The elimination of the primer allows, among other advantages, to zero the toxicological risk related thereto and to nullify the primer performance issues produced both by more severe environmental conditions (tropical conditions, characterized by high temperatures and high humidity), and by its consistency issues (problems of cohesion of the primer). The nitrogen-based functionalities introduced with flame NFT and in particular with flame NFT with hydrogen guarantee, in fact, as it is written above, adhesion and sealability performance not affected by tropical environmental conditions or by consistency issues, as instead occurs with the use of adhesion promoters.

Advantageously, the polymeric structures for packagings according to the present invention therefore allow to substantially reduce production costs and to simplify the production process, further reducing the environmental impact of the process itself.

Advantageously, the polymeric structures for packagings according to the present invention allow to obtain optimal physical-mechanical characteristics and adhesion between the polyolefinic surfaces without the use of primers.

Furthermore, the polymeric structures for packagings according to the invention are suitable for the application of coating, metallization, printing and lamination, without the use of primers.

Finally, it is evident that modifications and variations can be made to the polymeric structures for packagings described and shown herein without, however, departing from the scope of the present invention, as defined in the appended claims.

1. A polymeric structure for flexible packagings comprising:
a polymeric base film;
at least one first surface layer applied on at least one surface of the base film;
at least one first coating applied on at least one surface of the at least one first surface layer, without the use of any primer; and
wherein at least one surface of the base film or at least one surface of the first surface layer is treated with nitrous flame (NFT), in which use is made, as fuel gas, of combustible mixtures containing hydrogen (NH-FT).

2. The polymeric structure for flexible packagings according to claim 1, wherein the base film is constituted by a homopolymer in bi-oriented polypropylene with high isotactic content (BOPP), and the at least one first surface layer is constituted by a layer in terpolymers.

3. The polymeric structure for flexible packagings according to claim 1, wherein the base film is constituted by a homopolymer in bi-oriented polypropylene with high isotactic content (BOPP).

4. The polymeric structure for flexible packagings according to claim 1, wherein the base film is coextruded with a first surface layer and a second surface layer which are applied respectively to its first and its second surface, said first and second surface layers being each constituted by a copolymer or a terpolymer, and wherein both external surfaces of the first surface layer and of the second surface layer are treated with nitrous flame, in which use is made, as a fuel gas, also of mixtures containing hydrogen (NH-FT), at different times, to each of said treated external surfaces it being applied respectively a first coating and a second coating, without the use of any primer.

5. The polymeric structure for flexible packagings according to claim 4, wherein it has a thickness comprised between 6 μm and 100 μm and a grammage of the first coating and of the second coating comprised between 0.04 and 5 g/m².

6. The polymeric structure for flexible packagings according to claim 4, wherein said first coating is selected from the group constituted by: acrylic lacquer, PVDC lacquer, or a low-sealing lacquer, and in that said second coating is selected from the group constituted by: acrylic lacquer, PVDC lacquer, nitrocellulosic lacquer and polyester, without the use of primers.

7. The polymeric structure for flexible packagings according to claim 1, wherein
the base film is constituted by a homopolymer having both external surfaces treated with nitrous flame, in which use is made, as fuel gas, of mixtures containing hydrogen, at different times;
the first surface film is constituted by a PVOH or EVOH lacquer;
the second surface film is constituted by a terpolymer, or low-sealing lacquer (LTS), or acrylic lacquer;
the first coating is constituted by an acrylic lacquer.

8. The polymeric structure for packagings according to claim 7, wherein the second surface layer is in a terpolymer and at least one external surface thereof is treated with nitrous flame (NH-FT).

9. The polymeric structure for flexible packagings according to claim 1, wherein the base film is constituted by a homopolymer, the first surface layer and the second surface layer of a terpolymer, and the external surfaces respectively of the first surface layer and of the second surface layer are treated with nitrous flame (NFT), in which use is made, as a fuel gas, of mixtures containing hydrogen, at different times, the first coating being in mono-solvent nitrocellulose in ethyl acetate, and the external surface of the second surface layer being coated with a second coating in acrylic or low-sealing lacquer (LTS), without the use of any primer.

10. The polymeric structure for flexible packagings according to claim 1, comprising at least a third coating constituted by a layer of aluminium, or oxides thereof (AlOx), having optical density in the interval 0.5÷5, deposited on the base film in bi-oriented polypropylene with high isotactic content.

11. The polymeric structure for flexible packagings according to claim 1, wherein the base film is constituted by a material selected from the group constituted by:
polyolefins, oriented and not;
poly (ethylene terephthalate)-(PET);
bi-oriented poly (ethylene terephthalate)-BOPET;
bi-oriented polyamide (BOPA);
synthetic paper (SYNPA);
Fluoropolymers such as polyvinyl fluoride (PVF);
polyvinylidene fluoride (PVDF);
polytetrafluoroethylene (PTFE);
polyvinyl chloride (PVC);
Cast PP, Polypropylene;
Nylon;
polyethylene (PE);
Polyamide (PA);
polylactate (PLA);
polyhydroxyalkanoates (PHA);
poly-β-hydroxybutyrate (PHB);
polystyrene (PS);
Bioplastic films.

12. The polymeric structure for flexible packagings according to claim 1, wherein said first surface layer and said second surface layer are constituted by mixtures of a copolymer or of a terpolymer, and copolymers coming from aliphatic and cycloaliphatic hydrocarbons or by copolymers coming from aromatic hydrocarbons or from terpene resins.

13. A process for producing the polymeric structure for flexible packagings according to claim 1,
comprising the following steps:
a first step of stretching a mono-oriented polypropylene film, up to a thickness comprised in the interval from 160 μm to 550 μm and width comprised in the range 1.0 m-1.2 m;
a second step of stretching the polypropylene, in a direction transverse to the first step, up to a film thickness comprised in the interval from 18 μm to 60 μm and a width comprised in the range 6.6 m-10.4 m;
flame treatment NFT with addition of H₂ on at least one of the faces of the film obtained from the previous steps;
deposition on the face previously treated by NFT and H₂, by Reverse Gravure and Kiss Coating technique, of a high oxygen barrier lacquer, used without addition of primers.

14. A process for producing a polymeric structure for flexible packaging, said polymeric structure comprising:
a polymeric base film;
at least one first surface layer applied on at least one surface of the base film, wherein the process comprises the steps of:
applying at least one first coating on at least one surface of the at least one first surface layer, without the use of any primer;
treating at least one surface of the base film or at least one surface of the first surface layer with nitrous flame (NFT), in which use is made, as fuel gas, of combustible mixtures containing hydrogen (NH-FT).

15. The process according to claim 14, wherein the base film is constituted by a homopolymer in bi-oriented polypropylene with high isotactic content (BOPP), and the at least one first surface layer is constituted by a layer in terpolyme), or wherein the base film is constituted by a homopolymer in bi-oriented polypropylene with high isotactic content (BOPP).

16. The process according to claim 14, comprising the steps of:
coextruding the base film with a first surface layer and a second surface layer, and
applying respectively said first surface layer and a second surface to its first and its second surface, said first and second surface layers being each constituted by a copolymer or a terpolymer, and
treating both external surfaces of the first surface layer and of the second surface layer with nitrous flame, in which use is made, as a fuel gas, of mixtures containing hydrogen (NH-FT), at different times;
applying to each of said treated external surfaces respectively a first coating and a second coating, without the use of any primer.

17. The process according to claim 14, wherein the base film is constituted by a homopolymer and both external surfaces of the base film (re treated with nitrous flame, in which use is made, as fuel gas, of mixtures containing hydrogen (NH-FT), at different times; and wherein the first surface film is constituted by a PVOH or EVOH lacquer; the second surface film is constituted by a terpolymer, or low-sealing lacquer (LTS), or acrylic lacquer; the first coating is constituted by an acrylic lacquer.

18. The process according to claim 14, wherein the base film is constituted by a homopolymer, the first surface layer and the second surface layer of a terpolymer, comprising the step of treating the external surfaces respectively of the first surface layer and of the second surface layer, with nitrous flame (NFT), in which use is made, as a fuel gas, of mixtures containing hydrogen (NH-FT), at different times, wherein the first coating is in mono-solvent nitrocellulose in ethyl acetate, and the external surface of the second surface layer is coated with a second coating in acrylic or low-sealing lacquer (LTS), without the use of any primer.
